(19) United States
(12) Patent Application Publication
(10) Pub. No.: US 2009/0010023 A1
(43) Pub. Date: Jan. 8, 2009

(54) LIGHT SOURCE HAVING TRANSPARENT LAYERS

(75) Inventors: UDAYAN KANADE, Pune (IN); Gaurav Kulkarni, Sangli (IN); Karthikk Sridharan, Pune (IN); Manas Alekar, Pune (IN); Manohar D. Joshi, Pune (IN); Sanat D. Ganu, Pune (IN); Balaji Ganapathy, Pune (IN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: I2iC Corporation

(21) Appl. No.: 12/168,745

(22) Filed: Jul. 7, 2008

(30) Foreign Application Priority Data
Jul. 5, 2007 (IN) 1283/MUM/2007

(51) Int. Cl. F21V 7/04

(52) U.S. Cl. 362/606

(57) ABSTRACT

A system for providing a light source is disclosed. In one embodiment, the apparatus comprises a light guide made of several transparent layers having different refractive indexes.

The present patent claims priority to Indian Provisional Patent Number 1283/MUM/2007 titled “Transparent Light Source Using Heterogeneous Layers” filed on Jul. 5, 2007 and incorporated by reference.

### FIELD

The present invention relates to a light source. More particularly, the invention relates to a light source having transparent layers.

### BACKGROUND

Illumination is used to light up objects, for photography, microscopy, scientific purposes, entertainment productions (including theatre, television and movies), projection of images and as backlights or frontlights of displays.

Prior systems act as light sources in the form of a surface. Fluorescent lights for home lighting may be covered by diffuser panels to reduce the glare. These systems are bulky. They are also not transparent. Diffusers and diffuse reflectors such as umbrella reflectors are used as light sources for photography and cinematography, but they are only approximations to uniform lighting.

Backlights of flat-panel screens such as LCD screens provide uniform or almost uniform light. Prior solutions for backlighting an LCD screen is to have a light guide in the form of a sheet, with some shapes such as dots or prisms printed on it to extract light. The light guide is formed by sandwiching a high refractive index material between two low refractive index materials. The shape and frequency of dots is managed such that uniform illumination over the surface is achieved. These methods give uniform illumination over the surface, but the illumination is not uniform locally—when looked at closely the appearance is that of dots of glowing light surrounded by darkness. Such non-uniformity is not pleasing to the eye, and will cause disturbing Moiré patterns if used as a backlight for a flat panel screen. Such systems, to achieve local uniformity of light, need to be covered by diffuser panels or film, which makes them costlier, bulkier and non-transparent.

There are systems which provide uniform illumination over a surface in the local sense, i.e. locally, a surface is uniformly illuminated. These systems are similar to the systems described above, in the sense that they use a light guide and a method of extracting part of the light being guided. The light extraction, though, is not done with dots or geometric shapes, but with microscopic light scattering, diffracting or diffusing particles. Such particles are distributed uniformly throughout the light guide. This causes a continuously lighted light source, rather than one that is discretely lighted. On the other hand, as the light is guided from one end of the sheet to another, part of the light is extracted, causing lesser and lesser light left for extracting, and thus lesser and lesser illumination. Thus, these systems do not provide uniformity of illumination over the entire surface. To provide approximate uniformity, the total drop in light from one end of the light guide to the other should not be too large. This, though, will cause light to be wasted at the edge of the light guide, and thus the energy efficiency of the system goes down.

Some systems require a light source in the form of a surface which emanates polarized light. For example, liquid crystal displays require polarized light. Some systems require a light source in the form of a surface which emanates collimated or partially collimated light, that is, light which comes out in a narrow range of angles. For example, displays for personal viewing require light to come out at a narrow angle, so that light is not wasted in directions where the viewer is not present. A narrow angle of emanation also improves viewing privacy, as persons for whom the display is not meant to be seen will see no light or a very small amount of light. A light source which emanates collimated light is useful as backlight or frontlight for such displays.

### SUMMARY

A system for providing a light source is disclosed. In one embodiment, the apparatus comprises a light guide made of several transparent layers having different refractive indexes.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary light source as viewed from the side, according to one embodiment.

FIG. 2 illustrates an exemplary light guide as viewed from the side, according to one embodiment.

FIG. 3 illustrates an exemplary light guide element of a light guide, according to one embodiment.

FIG. 4 illustrates an exemplary light source with a light guide having a varied volume extinction coefficient, according to one embodiment.

FIG. 5 illustrates an exemplary light source having two primary light sources, according to one embodiment.

FIG. 6 illustrates an exemplary light source having a mirrored light guide, according to one embodiment.

FIG. 7 illustrates an exemplary light source according to one embodiment.

### DETAILED DESCRIPTION

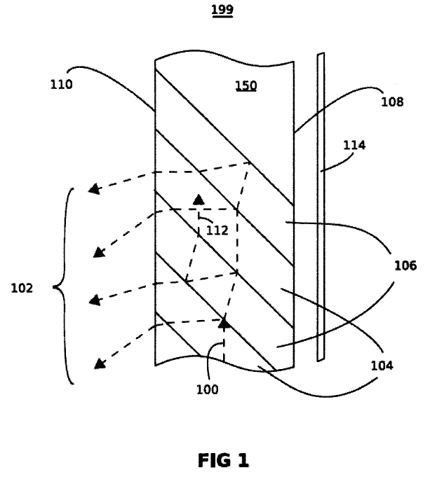

FIG. 1 illustrates a block diagram of an exemplary light source 199 as viewed from the side, according to one embodiment. The light source 199 has a light guide 150. The light guide 150 has transparent sheets 104 and transparent sheets 106 with different refractive indexes. In an embodiment, the transparent sheets 104 have a lower refractive index than that of transparent sheets 106. In an embodiment, the sheets 104 are placed alternately with the sheets 106 and make a particular angle with side 108 of light guide 199. Incident light ray 100 is an exemplary light ray generated by a light source (not shown). Light sources may be present at one or both ends of the light guide 150. The incident light ray 100 traverses the light guide 150. At each interface between the transparent sheets 104 and 106, the light ray 100 is partially reflected out of the light guide 150 and is partially refracted into the next sheet. Light rays 102 are light rays emanating out of light guide 150 due to partial reflection at the interfaces of the transparent sheets 104 and 106. A part of the incident light ray 100 that reaches the side 108 or side 110 of the light guide 150 without reflections, remains in the light guide due to interface reflection from side 108 or side 110. This interface reflection might be total internal reflection. Similarly, light traveling along the length of the light guide 150 such as light 112 formed by multiple reflections of incident light 100 will stay within the light guide 150 by internal reflection from the sides 108 and 110 of light guide 150. By varying the refractive indexes, slopes and thicknesses of the individual sheets 104 and 106, the emanated light rays 102 form a predetermined light emanation pattern.

In an embodiment, light guide 150 is primarily transparent to light falling on one of its sides 108 or 110. In an embodiment, light guide 150 is the light source 199. In this case, the light source 199 is a transparent light source.

In an embodiment, a sheet 114 is provided on one side of the light guide 150. In an embodiment, the sheet 114 is a mirror. Sheet 114 may have metallic surfaces, distributed Bragg reflectors, hybrid reflectors, total internal reflectors, omni-direction reflectors or scattering reflectors. A mirror improves the efficiency of light source 199 by reflecting the light falling on it from the light source 150. The light is reflected back through the transparent light guide 150 and emanates from the surface 110. Thus, due to the mirror, all the light emanates from only one side of the light source 199.

In another embodiment, the sheet 114 is a light absorbing surface. In this case, any light falling from outside onto the side 110 of the light guide 150, which is the front face of the light source 199, will pass through the light guide 150 and get absorbed by sheet 114. Thus, the light source 199 is a source of light with a very low reflectivity for external light. Such light sources have many uses. One use is as a backlight for transmissive displays such as liquid crystal displays. Since the ambient light falling on the backlight is primarily absorbed, a very high contrast ratio can be achieved in such displays.

In an embodiment, the light source producing incident light 100 produces polarized light. Thus, light ray 100 is a polarized light ray. Then, the light 102 coming out of the light source 199 is also polarized. The light source that produces light 100 may be any polarized light source, including a light source having polarizers, a light source with reflective polarizers, the present light source, a light emitting diode producing polarized light, etc.

In an embodiment, the light source producing incident light 100 produces collimated light, or light traveling in a narrow cone of angles. Then, the light emanating from light source 199 also travels in a narrow cone of angles. The light source that produces light 100 may be any collimated light source, including a light source with collimating lenses and optics, a light source including prism sheets, a light source with photonic materials, a light source as disclosed in the present patent, etc.

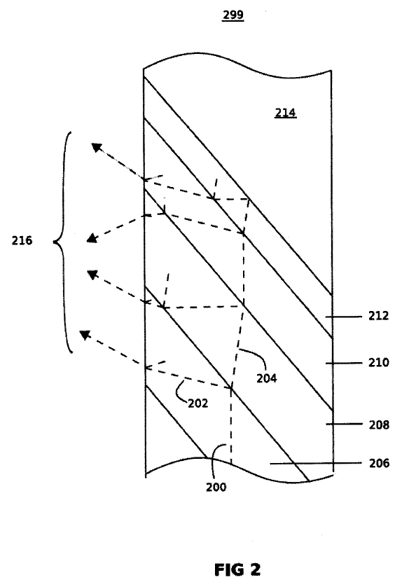

FIG. 2 illustrates a block diagram of an exemplary light guide 299 as viewed from the side, according to one embodiment. The light guide 299 has transparent sheets 206, 208, 210 and 212 having different refractive indexes and making a particular angle with the side of light guide 299. In an embodiment the transparent sheets 206 and 210 have the same refractive index and transparent sheets 208 and 212 have the same refractive index. In another embodiment sheets 206, 210 have lower refractive index than that of transparent sheets 208, 212. The light 200 is incident on the interface between sheets 206 and 208. A part of light 200 reflects as light 202 and a part refracts as light 204 into the next sheet 208. The intensity of refracted light is less than that of incident light at each interface between the transparent sheets. The light 200 undergoes one or more internal reflections and refractions and is emanated out of the light guide 299 as light 216. The thicknesses of the transparent sheets 206, 208, 210 and 212 are varied according to a particular function of distance from the bottom edge (not shown) of sheet 214. In an embodiment the thicknesses of the transparent sheets is decreased from bottom to top. By varying the refractive indexes, slants and thicknesses of the individual sheets 206, 208, 210 and 212, the emanated light 216 forms a predetermined light emanation pattern. In an embodiment the emanation pattern 216 is uniform throughout the sheet. In an embodiment the emanation pattern 216 is directional and all light emanated from the sheet 214 is directed in a predefined direction. In an alternate embodiment, the ratios of refractive indexes of the adjacent sheets 206, 208, 210 and 212 are varied according to a particular function of distance from bottom edge of sheet 214. According to one embodiment the ratio of refractive indexes of the adjacent sheets is increased from bottom to top.

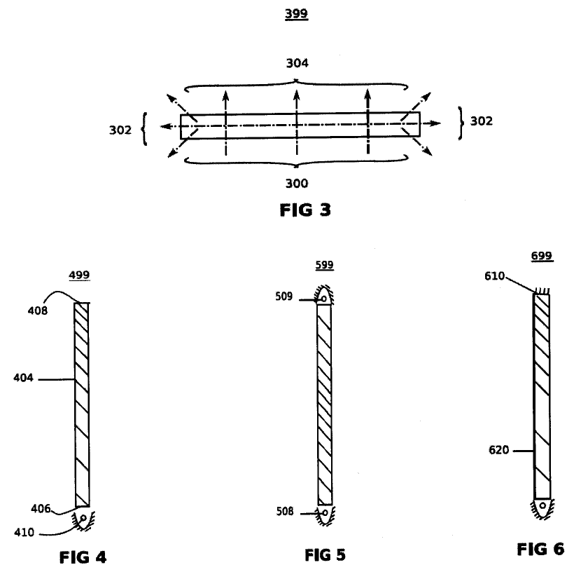

FIG. 3 illustrates a block diagram of an exemplary light guide element 399 of a light guide, according to one embodiment. Light guide element 399 has the thickness and breadth of the present light guide, but has a very small height. The light 300 undergoes one or more internal reflections and refractions and is emanated out of the light guide element 399 as light 302, and the remaining light 304 travels on to the next light guide element. The power of the light going in 300 is matched by the sum of the powers of the emanated light 302 and the light continuing to the next element 304. The ratio of fraction of light emanated 302 to the light 300 entering the light guide element 399, to the height of the light guide element 399 is the volume extinction coefficient of light guide element 399. As the height of light guide element 399 decreases, the volume extinction coefficient approaches a constant.

The light guide element 399 contains a number of layers of different refractive index. The reciprocal of the average height of a layer measured in the same direction that the height of the light guide element 399 is measured in, is the interface density at light guide element 399. The volume extinction coefficient of light guide element 399 bears a certain relationship to the interface density at the light guide element 399. The relationship is approximated to a certain degree as a direct proportion. The relationship is easy to evaluate by experimentation, and thus, knowing the interface density of an element allows evaluation of the volume extinction coefficient of light guide element 399, and vice versa.

The relative refractive index at an interface is the ratio of the refractive indexes of the two corresponding transparent layers. The relative refractive index of the interface is related to the reflectivity of the interface by Fresnel's law of reflection. The average interface reflectivity at the light guide element 399 is the average reflectivity over all the interfaces in the light guide element 399.

To a certain approximation, the volume extinction coefficient at light guide element 399 equals the interface density at light guide element 399 multiplied by the average interface reflectivity at light guide element 399.

As the height of light guide element 399 is reduced, power in the emanating light 302 reduces proportionately. The ratio of power of the emanating light 302 to the height of light guide element 399, which approaches a constant as the height of the element is reduced, is the linear irradiance at light guide element 399. The linear irradiance at light guide element 399 is the volume extinction coefficient times the power of the incoming light (i.e. power of light traveling through the element). The gradient of the power of light traveling through the light guide 304 is the negative of the linear irradiance. These two relations give a differential equation. This equation can be represented in the form “dP/dh=−qP=−K” where:

h is the height of a light guide element from the primary light source edge;

P is the power of the light being guided through that element;

q is the volume extinction coefficient of the element; and

K is the linear irradiance at that element.

This equation is used to find the emanated linear irradiance given the volume extinction coefficient at each element. This equation is also used to find the volume extinction coefficient of each element, given the emanated linear irradiance. To design a particular light source with a particular emanated linear irradiance, the above differential equation is solved to determine the volume extinction coefficient at each light guide element of the light guide, such as light guide 304. From this, the interface density at each light guide element of a light guide is determined. Such a light guide is used to give a light source of required emanated linear irradiance over the surface of the light source.

If a uniform interface density is used in the light guide, the linear irradiance drops exponentially with height. Uniform linear irradiance may be approximated by choosing a interface density such that the power drop from the edge near the light source to the opposite edge is minimized. To reduce the power loss and also improve the uniformity of the emanated power, the opposite edge reflects light back into the light guide. In an alternate embodiment, another primary light source sources light into the opposite edge.

To achieve uniform illumination, the volume extinction coefficient and hence the interface density, the interface reflectivity, or both has to be varied over the light guide surface. This can be done using the above methodology. In an embodiment, the volume extinction coefficient is varied using the formula q=K/(A−hK), where A is the power going into the light guide and K is the linear irradiance at each element, a constant number for uniform illumination. If the total height of the light guide is H, then H times K should be less than A, i.e. total power emanated should be less than total power going into the light guide, in which case the above solution is feasible. If the complete power going into the light guide is utilized for illumination, then H times K equals A, and thus the volume extinction coefficient q approaches infinity as h approaches H, i.e. for higher elements of the light guide. In one embodiment of the present invention, H times K is kept only slightly less than A, so that only a little power is wasted, as well as volume extinction coefficient is always finite.

FIG. 4 illustrates a diagram of an exemplary light source 499 with a light guide having a varied volume extinction coefficient, according to one embodiment. Light source 410 is placed adjacent to the light source end 406 of light guide 404. The interface density is varied from sparse to dense from the light source end 406 of light guide 404 to the opposite edge 408 of light guide 404. In another embodiment, the interface reflectivity is increased from the light source end 406 light guide 404 to the opposite end 408 of light guide 404. In another embodiment, the product of the interface reflectivity and interface density is increased from the light source end 406 of light guide 404 to the opposite end 408 of light guide 404.

FIG. 5 illustrates an exemplary light source 599 having two primary light sources, according to one embodiment. By using two primary light sources 508, 509, high variations in volume extinction coefficient in a light guide is not necessary. The differential equation provided above is used independently for deriving the linear irradiance due to each of the primary light sources 508, 509. The addition of these two power densities provides the total light power density emanated at a particular light guide element.

Uniform illumination for light source 500 is achieved by volume extinction coefficient q=1/sqrt((h−H/2)̂2+C/K̂2) where sqrt is the square root function, ̂ stands for exponentiation, K is the average linear irradiance per primary light source (numerically equal to half the total linear irradiance at each element) and C=A (A−HK). This volume extinction coefficient is achieved by varying interface density and interface reflectivity.

FIG. 6 illustrates a diagram of an exemplary light source 699 having a mirrored light guide, according to one embodiment. By using a mirrored light guide 620, high variations in volume extinction coefficient in the light guide 620 is not necessary. Top edge 610 of the light guide 620 is mirrored, such that it will reflect light back into light guide 620. The volume extinction coefficient to achieve uniform illumination in light source 600 is:

q=1/sqrt((h−H)̂2+D/K̂2)

where D=3A (A−HK). This volume extinction coefficient is achieved by varying interface density and interface reflectivity.

According to the present embodiments, the same pattern of emanation is sustained even if the primary light source power changes. For example, if the primary light source of light source 699 provides half the rated power, each element of the light guide 620 emanates half its rated power. Specifically, a light guide light guide 620 designed to act as a uniform illuminator acts as a uniform illuminator at all power ratings by changing the power of its primary light source or sources. If there are two primary light sources, their powers are changed in tandem to achieve this effect.

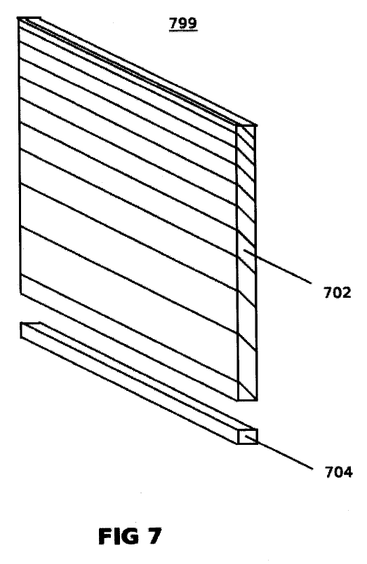

FIG. 7 illustrates a block diagram of a light source 799, according to one embodiment. A light guide 702 having transparent layers is illuminated by a light source 704. The light source 704 may have one or more of an incandescent light source, a solid state light source such as light emitting diode, a fluorescent tube, or a light source having transparent layers as disclosed above. In an embodiment, the light source 704 emanates polarized light and thus light guide 702 also emanates polarized light.

In an embodiment, the light source 704 emanates collimated light, or light emanated in a narrow cone of angles. Thus, light guide 702 also emanates collimated light. The output angle of the collimated light depends on the angle that the transparent layers of light guide 702 make with the side of light guide 702. The angle that the transparent layers of light guide 702 make with the side of light guide 702 is chosen so that a predetermined output angle of the collimated light is achieved. The angle that the transparent layers of light guide 702 make with the side of the light guide may be varied over the light guide 702 to give different angles of emanation at different places of light source 799.

A light source having transparent layers is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

We claim:

1. An apparatus comprising, a first light guide and a first light source placed adjacent to a first end of the first light guide wherein the first light guide has a plurality of first transparent sheets, the first transparent sheets being of at least two different refractive indexes, the first transparent sheets making an angle with the side of the first light guide.

2. The apparatus of claim 1 wherein the first light source is a polarized light source.

3. The apparatus of claim 1 wherein the first light source gives out light in a narrow cone of angles.

4. The apparatus of claim 1 wherein the height of the first transparent sheets is varied throughout the light guide.

5. The apparatus of claim 1 wherein the refractive index of the first transparent sheets is varied throughout the light guide.

6. The apparatus of claim 1 further comprising a mirror adjacent to the end of the first light guide opposite to the first end.

7. The apparatus of claim 1 further comprising a second light source adjacent to the end of the light guide opposite to the first end.

8. The apparatus of claim 1 wherein the first light source has a second light guide and a third light source placed adjacent to one end of the second light guide, the second light guide having a plurality of second transparent sheets, the second transparent sheets being of at least two different refractive indexes, the second transparent sheets making an angle with the side of the second light guide.

9. The apparatus of claim 1 further comprising a mirror placed adjacent to the first light guide.

10. The apparatus of claim 1 further comprising a light absorbing sheet placed adjacent to the first light guide.
